(19) United States
(12) Patent Application Publication
(10) Pub. No.: US 2026/0082417 A1
(43) Pub. Date: Mar. 19, 2026

(54) SYSTEMS AND METHODS FOR ENCODING SHORT MESSAGE SERVICE PRIORITY FOR INTERWORKING WITH EXTERNAL NETWORKS AND PROTOCOLS

(71) Applicant: Verizon Patent and Licensing Inc., Basking Ridge, NJ (US)

(72) Inventors: Toby Varughese JOHN, Murphy, TX (US); Shashi KOTVALI, Frisco, TX (US); Smitha KULKARNI, Irving, TX (US); James S. ABRAHAM, Carrollton, TX (US)

(73) Assignee: Verizon Patent and Licensing Inc., Basking Ridge, NJ (US)

(21) Appl. No.: 18/884,398

(22) Filed: Sep. 13, 2024

(51) Int. Cl. H04W 72/566; H04L 69/22

(52) U.S. Cl. CPC H04W 72/566; H04L 69/22

(57) ABSTRACT

A network device may receive a first protocol-based message that includes priority header information indicative of a priority level associated with a first user equipment (UE). The network device may encode the first protocol-based message into a second protocol-based message that includes a priority header field generated based on the priority header information. The network device may cause the second protocol-based message to be provided to a second UE associated with an intercarrier network.

### BACKGROUND

Modern telecommunications rely heavily on protocols for transmitting messages, with key protocols like the Session Initiation Protocol (SIP) serving as the backbone for many types of messaging, including short message service (SMS) messaging.

### BRIEF DESCRIPTION OF THE DRAWINGS

FIGS. 1A-1D are diagrams of an example associated with encoding SMS priority for interworking with external networks and protocols.

FIG. 2 is a diagram of an example environment in which systems and/or methods described herein may be implemented.

FIG. 3 is a diagram of example components of one or more devices of FIG. 2.

FIG. 4 is a flowchart of an example process for encoding SMS priority for interworking with external networks and protocols.

### DETAILED DESCRIPTION OF EXAMPLE EMBODIMENTS

The following detailed description of example implementations refers to the accompanying drawings. The same reference numbers in different drawings may identify the same or similar elements.

SIP is ideal for handling low to medium volumes of messages and is equipped to support critical communications by incorporating additional priority header information, which allows network functions and applications to provide relative treatment based on the urgency of the message. This is particularly important for public safety and emergency communications, where different levels of message priority are recognized and acted upon by carrier networks.

As the volume of SMS traffic escalates, particularly for medium-to-high volume transmissions, SIP is supplanted by the more efficient Short Message Peer-to-Peer (SMPP) protocol. The SMPP protocol is proficient in processing and routing bulk messages to various networks and servers. However, the SMPP protocol is unable to differentiate and uniquely prioritize messages as well as SIP. For example, messages transmitted for public safety, through a mission critical service (MCS) and a wireless priority service (WPS), are identified as critical within SIP but are not identified as critical with the SMPP protocol. This is because the SMPP protocol fails to provide sufficient ranges of priority, essentially lumping various levels of emergency communications into a single-tiered category. These challenges are compounded during disaster and crisis situations when networks become strained and resources are limited. Differentiating message priority levels becomes crucial to ensure that critical communications for public safety are not delayed or lost. Current limitations of the SMPP protocol prevent the systematic conveyance of relative priorities for SIP-based SMS traffic.

Thus, current techniques for handling priority SMS messages consume computing resources (e.g., processing resources, memory resources, communication resources, and/or the like), networking resources, and/or other resources associated with failing to ensure that high priority communications are reliably and accurately prioritized within network traffic, failing to adequately prioritize messages provided from a SIP-based network to an intercarrier network utilizing the SMPP protocol, failing to handle critical communications during emergency or disaster situations, and/or the like.

Some implementations described herein relate to a network device that encodes SMS priority for interworking with external networks and protocols. For example, the network device may receive a first protocol-based message that includes priority header information indicative of a priority level associated with a first UE. The network device may encode the first protocol-based message into a second protocol-based message that includes a priority header field generated based on the priority header information. The network device may cause the second protocol-based message to be provided to a second UE associated with an intercarrier network. In this way, a network device encodes SMS priority for interworking with external networks and protocols. For example, the network device may provide differentiated priority handling of messages between SIP and the SMPP protocol to ensure robust public safety and emergency communication services. The network device may encode a SIP-based message with priority header information into an SMPP-based message that includes a priority header field generated based on the priority header information. The priority header field may include a plurality of priority levels that provide differentiated routing and delivery of messages based on a designated priority level. The network device may also encode an SMPP-based message with a priority header field into a SIP-based message that includes priority header information generated based on the priority header field. Thus, the network device may conserve computing resources, networking resources, and/or other resources that would have otherwise been consumed by failing to ensure that high priority communications are reliably and accurately prioritized within network traffic, failing to adequately prioritize messages provided from a SIP-based network to an intercarrier network utilizing the SMPP protocol, failing to handle critical communications during emergency or disaster situations.

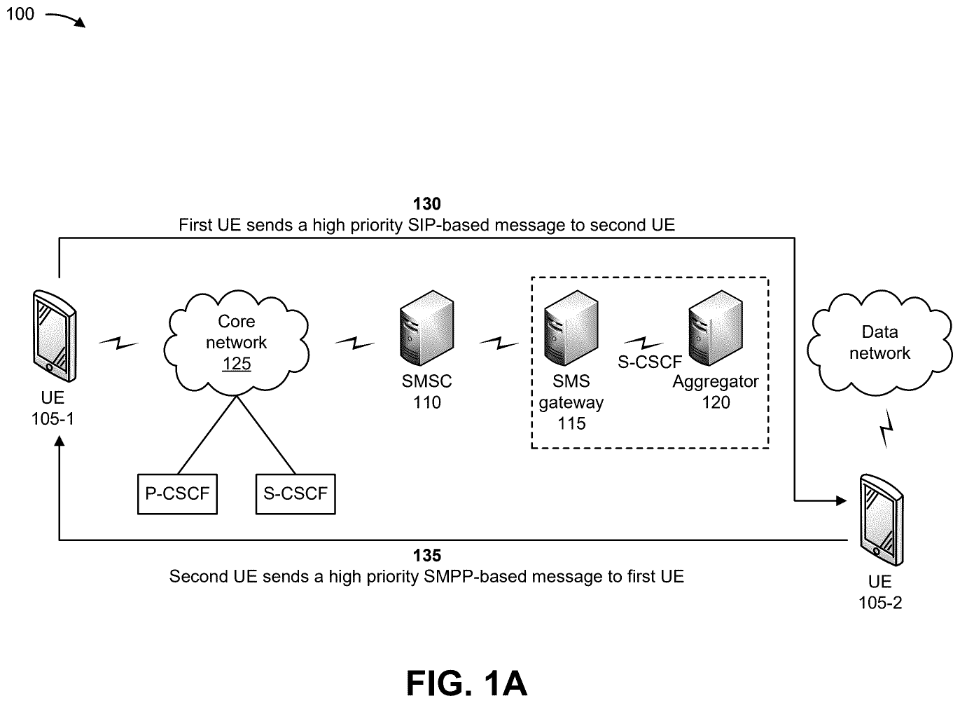

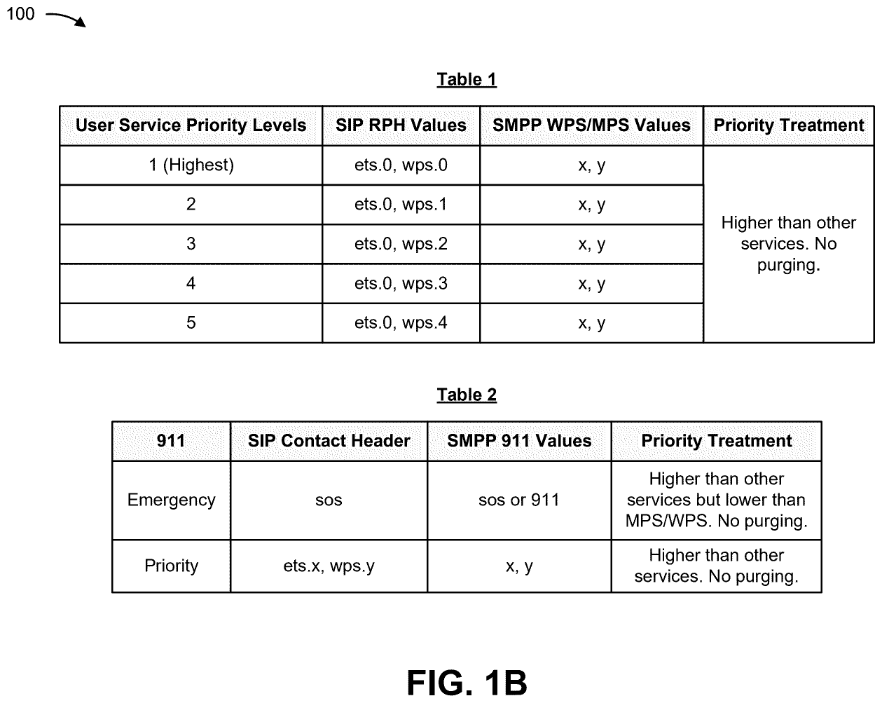

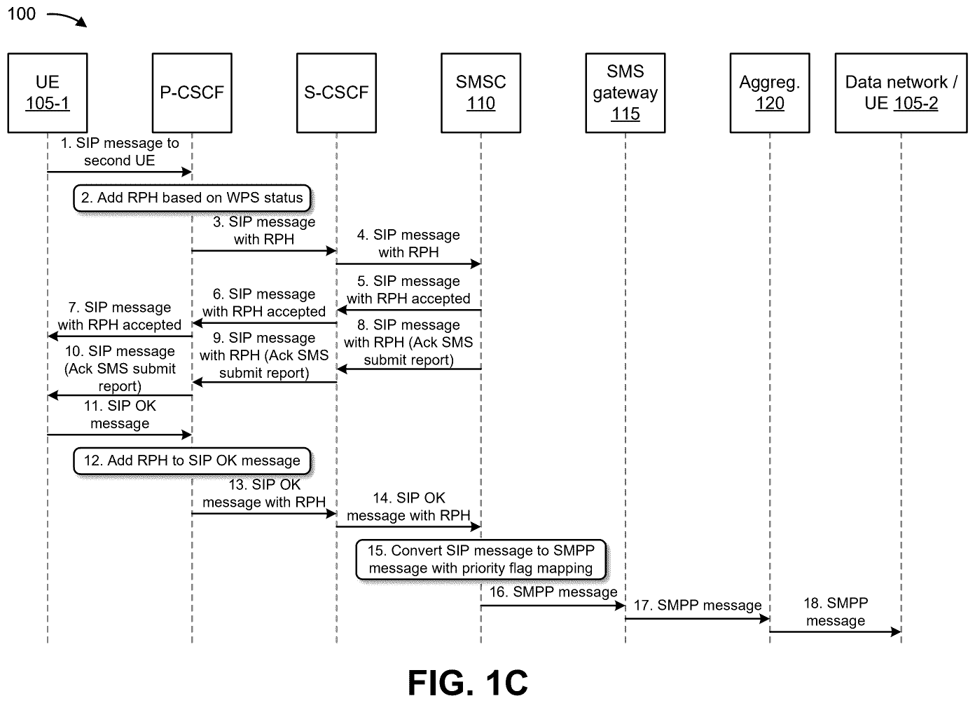

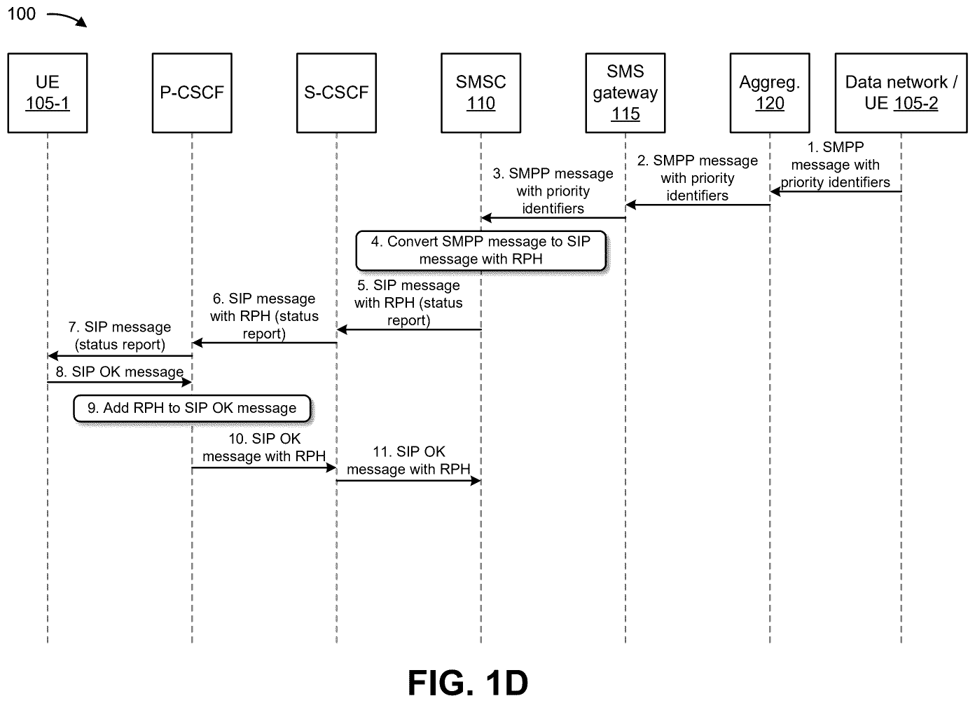

FIGS. 1A-1D are diagrams of an example 100 associated with encoding SMS priority for interworking with external networks and protocols. As shown in FIGS. 1A-1D, example 100 includes a first UE 105-1, a second UE 105-2, a short message service center (SMSC) 110, an SMS gateway 115, an aggregator 120, a data network, and a core network 125 associated with a proxy call session control function (P-CSCF) and a serving call session control function (S-CSCF). In some implementations, the UEs 105 may be associated with a high priority service, such as a multimedia priority service (MPS), mission critical service (MCS) (e.g., a public safety service), a high priority enterprise service, and/or the like. In some implementations, as shown by the dashed box in FIG. 1A, the SMS gateway 115 and the aggregator 120 may be combined into a single device that performs the functions of the SMS gateway 115 and the aggregator 120 described herein. Further details of the UEs 105, the SMSC 110, the SMS gateway 115, the aggregator 120, the data network, the core network 125, the P-CSCF, and the S-CSCF are provided elsewhere herein.

As shown in FIG. 1A, and by reference number 130, the first UE 105-1 may send a high priority SIP-based message to the second UE 105-2. For example, the first UE 105-1 may dynamically determine the priority level of the SIP-based message based on current network conditions and user-defined criteria, before providing the SIP-based message toward the second UE 105-2. This dynamic determination may involve real-time analysis of network traffic loads, user preferences, or application-specific requirements, ensuring that the SIP-based message is transmitted with an appropriate level of urgency. The first UE 105-1 or the P-CSCF may include a relative priority header, indicating the determined priority level, in the SIP-based message, and may provide the SIP-based message to the core network 125. The SIP-based message may be routed through the core network 125, the SMSC 110, the SMS gateway 115, the aggregator 120, and the data network before arriving at the second UE 105-2, as described in detail below in the connection with FIG. 1C.

Additionally, or alternatively, the first UE 105-1 may employ alternative header fields, in addition to or in place of the relative priority header, to convey the priority status of the SIP-based message to the second UE 105-2. These alternative header fields may include parameters such, as urgency labels, context flags, or service classifications that augment the priority indications, offering a more granular and context-aware approach to message prioritization. Furthermore, the first UE 105-1 may utilize encryption or integrity protection mechanisms, together with the relative priority header, to enhance the security of the high priority SIP-based message before sending the SIP-based message to the second UE 105-2. This enhanced security may involve the use of cryptographic protocols that safeguard message integrity and confidentiality, ensuring that priority information and the message contents remain tamper-proof during transmission.

As further shown in FIG. 1A, and by reference number 135, the second UE 105-2 may send a high priority SMPP-based message to the first UE 105-1. For example, the second UE 105-2 may dynamically determine the priority level of the SMPP-based message based on current network conditions and user-defined criteria, before providing the SMPP-based message toward the first UE 105-1. This dynamic determination may involve real-time analysis of network traffic loads, user preferences, or application-specific requirements, ensuring that the SMPP-based message is transmitted with an appropriate level of urgency. The second UE 105-2 may include a priority header field, indicating the determined priority level, in the SMPP-based message, and may provide the SMPP-based message to the data network. The SMPP-based message may be routed through the data network, the aggregator 120, the SMS gateway 115, the SMSC 110, and the core network 125 before arriving at the first UE 105-1, as described in detail below in the connection with FIG. 1D.

In some implementations, the priority header field may include one or more SMPP priority flags, which may be further categorized into sub-levels of priority for differentiated treatment. Furthermore, the second UE 105-2 may utilize encryption or integrity protection mechanisms, together with the priority header field, to enhance the security of the high priority SMPP-based message before sending the SMPP-based message to the first UE 105-1. This enhanced security may involve the use of cryptographic protocols that safeguard message integrity and confidentiality, ensuring that priority information and the message contents remain tamper-proof during transmission.

FIG. 1B depicts tables that include information associated with a relative priority header (RPH) included in SIP-based messages and a priority header field included in SMPP-based messages. For example, Table 1 includes a hierarchy of user service priority levels, associated SIP RPH values, and SMPP wireless priority service (WPS)/MPS values. The services identified in Table 1 may be provided high priority than other services and may not be purged by the SMSC 110. The services identified in Table 1 may include specific priority levels that do not undergo message purging, therefore favoring delivery of these messages over other messages even under network congestion.

Table 1 may enable the SMSC 110 to encode the SIP RPH values (e.g., ets.0, wps.0 for the highest user service priority level) into respective SMPP priority values, and vice versa. The encoding may maintain the intended priority treatment during message transport across networks, ensuring that higher service priority levels are honored over other services. In some implementations, the encoding of the SIP RPH values may include a mapping of SIP priority levels to a predefined range of priority levels in a SMPP priority flag. This may provide a more refined priority distinction and more precise control over message flow, and may ensure that messages of higher importance are treated with an appropriate level of urgency. Additionally, or alternatively, the encoding may include a dynamic adjustment of a mapping between SIP RPH values and the SMPP priority values based on real-time network conditions or predefined criteria. This flexibility allows the SMSC 110 to adapt to varying network environments and maintain effective communication during specific events or services.

Table 2 indicates how 911 emergency services are treated and includes a SIP contact header (e.g., with an sos indicator or priority indicators, such ets.x and wps.y) and corresponding SMPP 911 values (e.g., sos or 911 and x and y). These values ensure that emergency services have a designated priority treatment, which is higher than normal services but lower than the top tiers depicted in Table 1. The emergency services identified in Table 2 may not undergo message purging, therefore favoring delivery of these messages even under network congestion.

In some implementations, the SMSC 110 may utilize the tables to implement a queuing strategy that orders messages based on encoded SMPP priority levels. The queue may ensure that messages with higher priority are transmitted out first, especially during peak network traffic times, thereby prioritizing critical communications such as 911 emergency service messages over less urgent traffic. Additionally, or alternatively, the SMSC 110 may apply an integrity check or validation process to ensure correct encoding and assignment of priority levels during a conversion process between protocols, thus preserving the integrity of the priority levels assigned to messages crucial for emergency services. Both tables may provide a system that ensures differentiated delivery of messages based on a priority level associated with MCS, MPS, WPS, or higher-tier enterprise services. By encoding priority information effectively across differing messaging protocols, the SMSC 110 may maintain service priorities in a multi-protocol environment.

FIG. 1C depicts an example information flow diagram associated with encoding SMS priority for interworking with external networks and protocols. As shown at step 1 of the FIG. 1C, the first UE 105-1 may provide, to the P-CSCF, a high priority SIP message that is destined for the second UE 105-2. For example, the first UE 105-1 may generate a SIP message (e.g., with high priority) that is destined for the second UE 105-2. The first UE 105-1 may dynamically determine the priority level of the SIP message based on current network conditions and user-defined criteria, before providing the SIP message toward the second UE 105-2. This dynamic determination may involve real-time analysis of network traffic loads, user preferences, or application-specific requirements, ensuring that the SIP message is transmitted with an appropriate level of urgency.

As shown at steps 2 and 3, the P-CSCF may add a relative priority header (RPH) (e.g., indicating the high priority) to the SIP message, and may provide the SIP message with the RPH to the S-CSCF. For example, if the first UE 105-1 does not provide the RPH in the SIP message, the P-CSCF may analyze the SIP message and information indicating that the first UE 105-1 is a high priority UE 105 to determine that the RPH needs to be added to the SIP message. The P-CSCF may add the RPH in the SIP message. The RPH may indicate a priority level for the SIP message and/or the first UE 105-1 that is determined based on analysis of the SIP message and the information indicating that the first UE 105-1 is a high priority UE 105. The P-CSCF may provide the SIP message with the RPH to the S-CSCF to inform the S-CSCF about the priority level for the SIP message and/or the first UE 105-1.

As shown at step 4, the S-CSCF may provide the SIP message with the RPH to the SMSC 110. For example, the S-CSCF may forward that SIP message with the RPH to the SMSC 110 to inform the SMSC 110 about the priority level for the SIP message and/or the first UE 105-1 and so that the SMSC 110 may encode the SIP message with the RPH to an SMPP message with a priority flag mapping that corresponds to the RPH, as described in connection with step 15.

Additionally, or alternatively, the SMSC 110 may temporarily store the SIP message with the RPH in a priority queue before forwarding to ensure that high priority messages are processed first in times of network congestion. This prioritization may be important during peak times or emergencies, where specific communications are deemed more critical and need to be delivered ahead of other messages. Additionally, or alternatively, the SMSC 110 may perform an integrity check of the SIP message to confirm that the RPH remains unaltered during transit. The integrity check may ensure a trustworthiness and reliability of the RPH and may prevent unauthorized alterations to the RPH of the SIP message.

As shown at step 5, the SMSC 110 may accept the SIP message with the RPH, and may provide, to the S-CSCF, an indication that the SIP message with the RPH has been accepted by the SMSC 110. For example, the SMSC 110 may accept the SIP message with the RPH based on determining that the priority level for the SIP message and/or the first UE 105-1 is correct. The SMSC 110 may generate the indication that the SIP message with the RPH has been accepted by the SMSC 110 based on accepting the SIP message with the RPH. The SMSC 110 may then provide the indication to the S-CSCF to inform the S-CSCF that the SIP message with the RPH has been accepted by the SMSC 110. Additionally, or alternatively, the SMSC 110 may acknowledge receipt of the SIP message with the RPH by providing a confirmation receipt to the S-CSCF, which may be used to notify the first UE 105-1 of successful delivery, as this may further enhance the feedback mechanism for priority message handling and delivery confirmation.

As shown at step 6, the S-CSCF may provide, to the P-CSCF, the indication that the SIP message with the RPH has been accepted by the SMSC 110. For example, the S-CSCF may provide the indication to the P-CSCF to inform the P-CSCF that the SIP message with the RPH has been accepted by the SMSC 110. In some implementations, the P-CSCF may provide an expedited routing option for the SIP message with the RPH, selecting a transmission path that prioritizes the SIP message over other messages. Providing such expedited routing may ensure minimization of latency for high-priority communications, which may be critical for time-sensitive applications such as emergency services or mission-critical operations.

As shown at step 7, the P-CSCF may provide, to the first UE 105-1, the indication that the SIP message with the RPH has been accepted by the SMSC 110. For example, the P-CSCF may provide the indication to the first UE 105-1 to inform the first UE 105-1 that the SIP message with the RPH has been accepted by the SMSC 110. In some implementations, the P-CSCF may suppress transmission of non-priority messages while the SIP message with the RPH is routed to the second UE 105-2 to ensure timely delivery of priority communications. By suppressing non-priority traffic, network resources can be allocated more efficiently towards ensuring the rapid transit of priority messages, thereby enhancing a quality of service (QOS) for such transmissions.

As shown at step 8, the SMSC 110 may provide, to the S-CSCF, an acknowledgement of an SMS submit report associated with the SIP message with the RPH. For example, the SMSC 110 may generate the acknowledgement of the SMS submit report associated with the SIP message with the RPH based on accepting the SIP message with the RPH. The SMSC 110 may forward the acknowledgement to the S-CSCF to inform the S-CSCF of the SMS submit report.

As shown at step 9, the S-CSCF may provide, to the P-CSCF, the acknowledgement of the SMS submit report associated with the SIP message with the RPH. For example, the S-CSCF may provide the acknowledgement of the SMS submit report associated with the SIP message with the RPH to the P-CSCF to inform the P-CSCF of the SMS submit report.

As shown at step 10, the P-CSCF may provide, to the first UE 105-1, the acknowledgement of the SMS submit report associated with the SIP message. For example, the P-CSCF may provide the acknowledgement of the SMS submit report associated with the SIP message with the RPH to the first UE 105-1 to inform the first UE 105-1 of the SMS submit report.

As shown at step 11, the first UE 105-1 may provide, to the P-CSCF, a SIP OK message in response to the acknowledgement of the SMS submit report associated with the SIP message. For example, in response to receiving the indication that the SIP message with the RPH has been accepted by the SMSC 110 and the acknowledgement of the SMS submit report, the first UE 105-1 may generate the SIP OK message acknowledging the receipt of the indication and the acknowledgement of the SMS submit report. The SIP OK message may include a status of the SMS submit report, indicating a completed communication transaction related to the SIP message with the RPH. The SIP OK message may represent confirmation, of the first UE 105-1 to the network, that the SMS submit report acknowledgment has been processed successfully.

As shown at step 12, the P-CSCF may add the RPH to the SIP OK message. For example, upon receive of the SIP OK message from the first UE 105-1, the P-CSCF may add the RPH to the SIP OK message. The P-CSCF may utilize priority header information initially included with the RPH of the SIP message to maintain a priority status of the communication as the SIP message progresses towards the second UE 105-2, ensuring that the priority level initially assigned is carried through subsequent network elements. In some implementations, the P-CSCF may include, with the SIP OK message, multiple priority levels instead of a single RPH, providing more control over message routing priorities. The multiple priority levels may provide differentiated treatment of the SIP message based on various service level agreements (SLAs) or network policies.

As shown at step 13, the P-CSCF may provide, to the S-CSCF, the SIP OK message with the RPH. For example, the P-CSCF may provide the SIP OK message with the RPH to the S-CSCF to inform the S-CSCF about the SIP OK message and for provision of the SIP OK message to the SMSC 110.

As shown at step 14, the S-CSCF may provide, to the SMSC 110, the SIP OK message with the RPH. For example, the S-CSCF may provide the SIP OK message with the RPH to SMSC 110 to inform the SMSC 110 about the completed communication transaction related to the SIP message with the RPH.

As shown at step 15, the SMSC 110 may determine that the second UE 105-2 is associated with an intercarrier network and may convert the SIP message with the RPH to an SMPP message with a priority flag mapping based on the RPH. For example, based on the SIP OK message with the RPH, the SMSC 110 determine that the second UE 105-2 is associated with an intercarrier network and needs to be converted to another protocol (e.g., the SMPP protocol). The SMSC 110 may convert the SIP message with the RPH to an SMPP message with a priority flag mapping. Additionally, or alternatively, the SMSC 110 may encrypt the SIP message with the RPH during conversion to the SMPP message, enhancing security of the priority information during intercarrier transport. Encryption may safeguard the communicated data against unauthorized access or tampering, thereby reinforcing the trust in the communication chain where priority headers necessitate stricter confidentiality. After converting the SIP message to the SMPP message, the SMSC 110 may cache the SMPP message in a separate priority message queue that is exempt from standard SMS purging practices, ensuring that critical messages are not lost. This may ensure a higher level of reliability and availability for high-importance communications, which could be imperative in emergency scenarios.

As shown at step 16, the SMSC 110 may provide the SMPP message with the priority flag mapping to the SMS gateway 115. For example, the SMSC 110 may forward the SMPP message with the priority flag mapping toward the second UE 105-2 by providing the SMPP message with the priority flag mapping to the SMS gateway 115. In addition to providing the SMPP message to the SMS gateway 115, the SMSC 110 may dynamically adapt a transmission priority of the SMPP message based on real-time network congestion levels. The ability to adaptively modify transmission priorities may be particularly advantageous in maintaining service quality during varying network conditions.

As shown at step 17, the SMS gateway 115 may provide the SMPP message with the priority flag mapping to the aggregator 120. For example, the SMS gateway 115 may be associated with the aggregator 120 that receives SMPP messages and aggregates the SMPP messages. In some implementations, the aggregator 120 may act as an intermediary between businesses or bulk SMS senders and UEs 105. The aggregator 120 may facilitate the sending of large volumes of SMS messages, and may optimize the routing of SMS messages to ensure the SMS messages utilize a most efficient and cost-effective path.

As shown at step 18, the aggregator 120 may provide the SMPP message with the priority flag mapping to the second UE 105-2, via the data network. For example, the aggregator 120 may provide the SMPP message with the priority flag mapping to the data network, and the data network may route the SMPP message to the second UE 105-2. In some implementations, the aggregator 120 may apply expedited delivery to the SMPP message, such as overriding standard delivery schedules, to ensure that the SMPP message with the priority flag mapping is delivered promptly to the second UE 105-2. Quick delivery may be essential for the effectiveness of the communication, especially in scenarios where the information may be time-critical or pertains to urgent matters.

FIG. 1D depicts an example information flow diagram associated with encoding SMS priority for interworking with external networks and protocols. As shown at step 1, the second UE 105-2 may generate an SMPP message with priority identifiers and destined for the first UE 105-1, and may provide the SMPP message with the priority identifiers to the aggregator 120, via the data network. For example, the second UE 105-2 may create the SMPP message for delivery to the first UE 105-1 and may include unique priority identifiers within the SMPP message that are indicative of a specific messaging priority level. In some implementations, the priority identifiers may correspond to MCS, MPS, or higher-tier enterprise subscriber categories, ensuring that the SMPP message is afforded an appropriate level of urgency within the network. Additionally, or alternatively, the second UE 105-2 may generate an SMPP message designated for priority communication with embedded indicators that reference specific priority levels, such as for emergency services or first responders, to ensure timely and differentiated handling in network traffic. The second UE 105-2 may forward the SMPP message toward the first UE 105-1 by providing the SMPP message to the data network. The data network may forward the SMPP message with the priority identifiers to the aggregator 120.

As shown at step 2, the aggregator 120 may provide the SMPP message with the priority identifiers to the SMS gateway 115. For example, the aggregator 120 may act as an intermediary in the message routing process, receiving the SMPP message from the data network and forwarding the SMPP message to the SMS gateway 115 while preserving the priority identifiers. This may maintain the priority information as the SMPP message traverses different network components. Additionally, or alternatively, the aggregator 120 may not only route the SMPP message but also may perform an aggregation function by bundling multiple messages based on similarity in priority levels or destination before forwarding to the SMS gateway 115. This aggregation capability may streamline message delivery, optimize network resources, and ensure a collective handling of similarly prioritized messages for efficient processing.

As shown at step 3, the SMS gateway 115 may provide the SMPP message with the priority identifiers to the SMSC 110. For example, the SMS gateway 115 may act as an intermediary in the message routing process, receiving the SMPP message from the aggregator 120 and forwarding the SMPP message to the SMSC 110 while preserving the priority identifiers. Additionally, or alternatively, the SMS gateway 115 may assign network resources accordingly to meet QoS requirements specified by the priority identifiers during SMPP message provision to the SMSC 110. This may ensure that messages with higher priority levels are given precedence in terms of resource allocation and transmission protocols.

As shown at step 4, the SMSC 110 may convert the SMPP message to a SIP message with an RPH generated based on the priority identifiers. For example, the SMSC 110 may be a conversion point between the SMPP protocol and SIP by transforming the SMPP message to the SIP message while retaining and encoding the prioritization data into a form that is recognizable and actionable by SIP-based network elements. Additionally, or alternatively, the SMSC 110 may employ a dynamic mapping strategy where the conversion of the SMPP message to the SIP message is based on real-time network conditions or user-specific profiles to generate a more context-aware RPH. This may further tailor the urgency and the handling of the SMPP message to the specific needs or statuses of the UEs 105 or a current operational state of the network.

As shown at step 5, the SMSC 110 may provide the SIP message with the RPH and a status report to the S-CSCF. For example, the SMSC 110 may provide the SIP message and the status report to the S-CSCF to ensure that the S-CSCF receives both the SIP message for routing to a final destination and the status report for tracking and confirmation purposes. Additionally, or alternatively, upon providing the SIP message with the RPH to the S-CSCF, the SMSC 110 may also append a detailed delivery report that includes metrics such as message latency, path taken, and any prioritization actions applied, to provide a comprehensive status report to the S-CSCF. Including such detailed metrics may aid in message traceability and quality assurance, thereby optimizing the overall messaging process and experience.

As shown at step 6, the S-CSCF may provide the SIP message with the RPH and the status report to the P-CSCF. For example, the S-CSCF may act as a controller within the core network 125, passing on the SIP message with its critical priority header and associated status information to the P-CSCF for progression towards the first UE 105-1. Additionally, or alternatively, the S-CSCF may redirect the SIP message with the RPH and the status report to an alternate P-CSCF, based on real-time network load distribution, thereby maintaining the service quality for the status report. Redistributing SIP messages across various P-CSCFs according to a dynamic state of the network may further enhance the reliability and efficiency of priority message delivery, ensuring that high-priority messages are not delayed or lost due to congestion issues.

As shown at step 7, the P-CSCF may provide the SIP message with the status report to the first UE 105-1. For example, by providing the SIP message and the status report, the P-CSCF may ensure that the first UE 105-1 receives the essential communication (e.g., the SIP message) along with a report on transmission status. Additionally, or alternatively, the P-CSCF may incorporate additional context or instructions specific to the SIP message, such as user-relevant advisories or operational directives that are pertinent to the SIP message's priority level or subject matter, which could result in a more informed and efficient response from a recipient associated with the first UE 105-1.

As shown at step 8, the first UE 105-1 may provide, to the P-CSCF, a SIP OK message in response to the SIP message with the status report. For example, the first UE 105-1 may generate the SIP OK message as an acknowledgment of receipt of the SIP message and the status report, completing a loop in the communication cycle (e.g., by providing the SIP OK message to the P-CSCF). Additionally, or alternatively, the first UE 105-1 may also generate an optional feedback message that provides insights into an efficacy of the received prioritization, creating a feedback loop to the P-CSCF. Such feedback may enable the P-CSCF to calibrate or adjust message prioritization mechanisms based on real-world data and user experiences.

As shown at step 9, the P-CSCF may add the RPH to the SIP OK message. As shown at step 9, the P-CSCF may add the RPH to the SIP OK message. For example, by incorporating the RPH into the SIP OK message, the P-CSCF may indicate an importance of the content of the SIP OK message and a priority status of the first UE 105-1. Additionally, or alternatively, the P-CSCF may also embed a timestamp or a digital signature into the SIP OK message to further certify the priority status and provide an auditable trail for the prioritized communication. This may authenticate the priority claim of the SIP OK message and may furnish a chronological log, thereby enhancing the traceability and verification of the communication's priority credentials.

As shown at step 10, the P-CSCF may provide, to the S-CSCF, the SIP OK message with the RPH. For example, by providing the SIP OK message with the RPH to the S-CSCF, the P-CSCF may ensure that network signaling layers remain informed of the successful delivery acknowledgment to the SIP message. Additionally, or alternatively, the P-CSCF may also indicate a preferred route or method for the SIP OK message to be transmitted back to the SMSC 110, based on priority considerations. Such explicit routing guidance may prioritize expedited or secure transmission paths for message acknowledgments.

As shown at step 11, the S-CSCF may provide, to the SMSC 110, the SIP OK message with the RPH. For example, the communication loop may conclude with the S-CSCF relaying the SIP OK message to the SMSC 110, effectively notifying the network that the message delivery cycle, with respective priority attributes, has been processed. Additionally, or alternatively, the S-CSCF may also include predictive indicators or suggestions for future optimizations in handling similar messages, to continuously refine the priority treatment mechanism within the network infrastructure.

In this way, a network device (e.g., the SMSC 110) encodes SMS priority for interworking with external networks and protocols. For example, the SMSC 110 may provide differentiated priority handling of messages between SIP and the SMPP protocol to ensure robust public safety and emergency communication services. The SMSC 110 may encode a SIP-based message with priority header information into an SMPP-based message that includes a priority header field generated based on the priority header information. The priority header field may include a plurality of priority levels that provide differentiated routing and delivery of messages based on a designated priority level. The SMSC 110 may also encode an SMPP-based message with a priority header field into a SIP-based message that includes priority header information generated based on the priority header field. Thus, the SMSC 110 may conserve computing resources, networking resources, and/or other resources that would have otherwise been consumed by failing to ensure that high priority communications are reliably and accurately prioritized within network traffic, failing to adequately prioritize messages provided from a SIP-based network to an intercarrier network utilizing the SMPP protocol, failing to handle critical communications during emergency or disaster situations.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

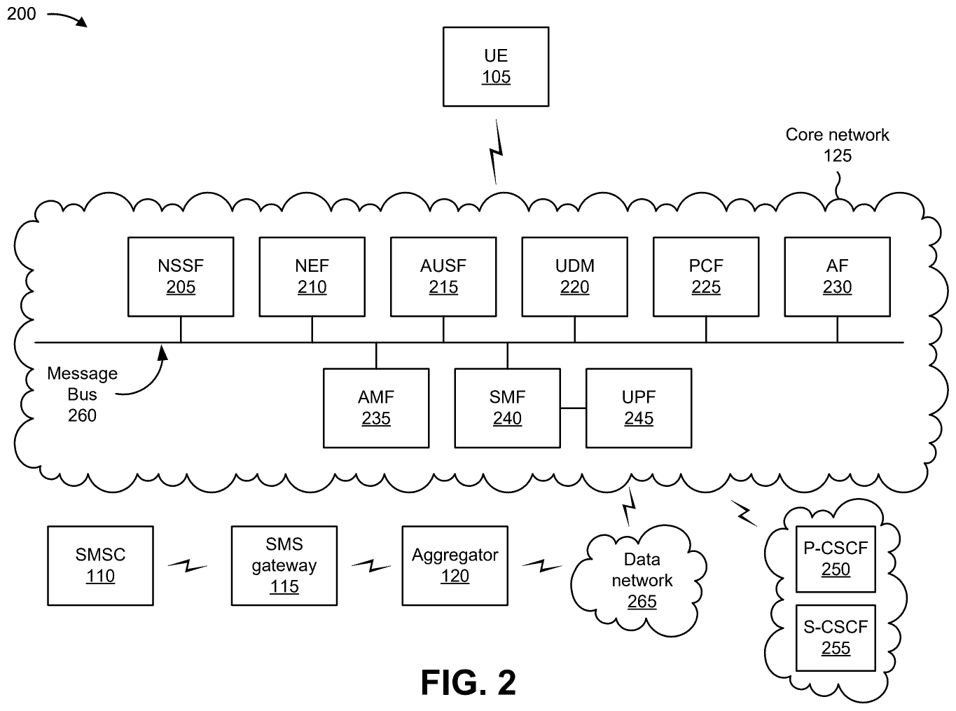

FIG. 2 is a diagram of an example environment 200 in which systems and/or methods described herein may be implemented. As shown in FIG. 2, the example environment 200 may include a UE 105, the SMSC 110, the SMS gateway 115, the aggregator 120, the core network 125, and a data network 265. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The SMSC 110 includes one or more devices capable of receiving, generating, storing, processing, and/or providing information, such as information described herein. For example, the SMSC 110 may store SMS messages when a recipient is not available, and may forwards SMS message to the recipient when available. The SMSC 110 may generate delivery reports to inform a sender about a delivery status of SMS messages, and may determine the best route to deliver an SMS message. The SMSC 110 may handle encoding and transmission of messages across different networks, and may manage transfer protocols necessary for SMS delivery, including SMPP.

The SMS gateway 115 includes one or more devices capable of receiving, generating, storing, processing, and/or providing information, such as information described herein. For example, the SMS gateway 115 may facilitate sending and receiving of SMS messages between different types of systems, networks, and applications. The SMS gateway 115 may be responsible for route optimization, determining the most efficient and cost-effective path for delivering SMS messages, and may encode SMS messages between different communication protocols. The SMS gateway 115 may ensure compatibility and interoperability between different types of networks, and may enable the sending of large volumes of SMS messages simultaneously. The SMS gateways may support both sending (e.g., mobile originated (MO)) and receiving (e.g., mobile terminated (MT)) SMS messages.

The aggregator 120 may include one or more devices capable of receiving, generating, storing, processing, providing, and/or routing information, such as information described herein. The aggregator 120 may include a communication device and/or a computing device. For example, the aggregator 120 may include a server, such as an application server, a client server, a web server, a database server, a host server, a proxy server, a virtual server (e.g., executing on computing hardware), or a server in a cloud computing system. In some implementations, the aggregator 120 may include computing hardware used in a cloud computing environment. The aggregator 120 may act as an intermediary between businesses or bulk SMS senders and mobile network operators. The aggregator 120 may facilitate the sending of large volumes of SMS messages, and may optimize the routing of SMS messages to ensure the SMS messages utilize a most efficient and cost-effective path. The aggregator 120 may handle the encoding and transfer of SMS messages across various protocols, such as SMPP, and may ensure that SMS messages are delivered successfully to recipients.

In some implementations, the core network 125 may include an example functional architecture in which systems and/or methods described herein may be implemented. For example, the core network 125 may include an example architecture of a fifth generation (5G) next generation (NG) core network included in a 5G wireless telecommunications system. While the example architecture of the core network 125 shown in FIG. 2 may be an example of a service-based architecture, in some implementations, the core network 125 may be implemented as a reference-point architecture and/or a 4G core network, among other examples.

As shown in FIG. 2, the core network 125 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. A network, such as an Internet protocol multimedia subsystem (IMS) network, may also include functional elements, such as a P-CSCF 250 and/or an S-CSCF 255. The P-CSCF 250 and/or the S-CSCF 255 may communicate with the core network 125. The functional elements of the core network 125 may be communicatively connected via a message bus 260. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 125.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The P-CSCF 250 includes one or more devices that act as an entry point for all SIP signaling messages from UEs 105. The P-CSCF 250 may process and forward SIP messages to appropriate entities within a network, such as an Internet protocol multimedia subsystem (IMS) network (e.g., the data network 265). The P-CSCF 250 may authenticate users before granting access to IMS services, and may ensure secure communication by performing encryption and decryption of SIP messages. The P-CSCF 250 may manage Quality of Service (QOS) for sessions, and may enforce local policies such as permission rules, screening of SIP messages, and handling emergency calls. The P-CSCF 250 may route SIP messages to the S-CSCF 255, and may invoke services on behalf of a user, such as call forwarding, conferencing, and other supplementary services.

The S-CSCF 255 includes one or more devices that handle session state for registered users, and that are responsible for routing SIP messages to the appropriate application servers.

The S-CSCF 255 may be involved in the user registration process within the IMS network, and may authorize and enforce user-network interactions. The S-CSCF 255 may influence QoS policies during session establishment and modification, and may interact with application servers to invoke user services. It supports various service control and execution functions, such as initiating call forwarding, conferencing, and other supplementary services. The S-CSCF 255 may ensure that only authenticated and authorized users access IMS services.

The message bus 260 represents a communication structure for communication among the functional elements. In other words, the message bus 260 may permit communication between two or more functional elements.

The data network 265 includes one or more wired and/or wireless data networks. For example, the data network 265 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

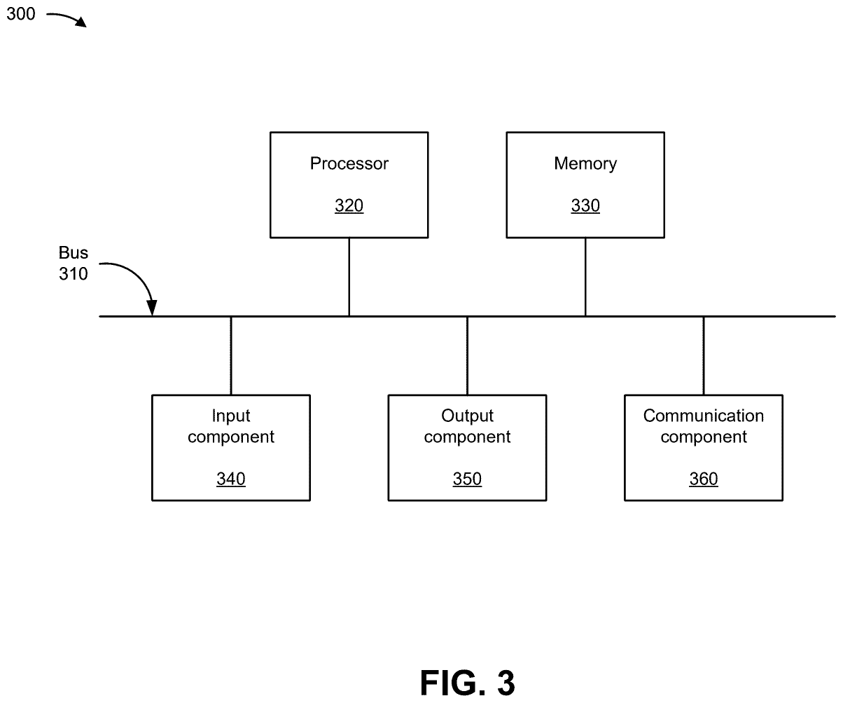

FIG. 3 is a diagram of example components of a device 300, which may correspond to the UE 105, the SMSC 110, the SMS gateway 115, the aggregator 120, the NSSF 205, the NEF 210, the AUSF 215, the UDM 220, the PCF 225, the AF 230, the AMF 235, the SMF 240, the UPF 245, the P-CSCF 250, and/or the S-CSCF 255. In some implementations, the UE 105, the SMSC 110, the SMS gateway 115, the aggregator 120, the NSSF 205, the NEF 210, the AUSF 215, the UDM 220, the PCF 225, the AF 230, the AMF 235, the SMF 240, the UPF 245, the P-CSCF 250, and/or the S-CSCF 255 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

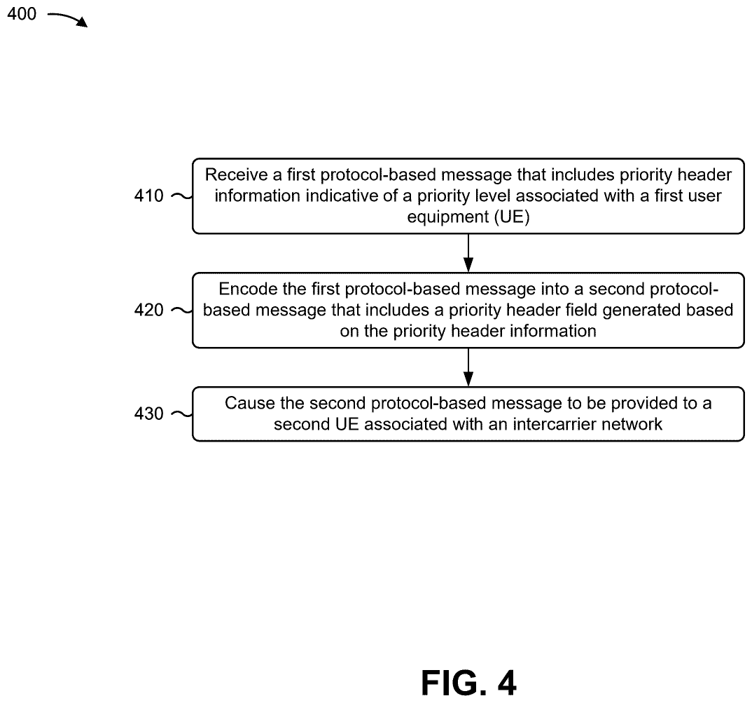

FIG. 4 is a flowchart of an example process 400 for encoding SMS priority for interworking with external networks and protocols. In some implementations, one or more process blocks of FIG. 4 may be performed by a network device (e.g., the SMSC 110). In some implementations, one or more process blocks of FIG. 4 may be performed by another device or a group of devices separate from or including the network device, such as a P-CSCF (e.g., the P-CSCF 250) and/or an S-CSCF (e.g., the S-CSCF 255). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a first protocol-based message that includes priority header information indicative of a priority level associated with a first UE (block 410). For example, the network device may receive a first protocol-based message that includes priority header information indicative of a priority level associated with a first UE, as described above.

As further shown in FIG. 4, process 400 may include encoding the first protocol-based message into a second protocol-based message that includes a priority header field generated based on the priority header information (block 420). For example, the network device may encode the first protocol-based message into a second protocol-based message that includes a priority header field generated based on the priority header information, as described above. In some implementations, the first protocol-based message is a SIP-based message, and the second protocol-based message is an SMPP protocol-based message. In some implementations, the priority header field includes a plurality of priority levels for routing the second protocol-based message. In some implementations, the priority header field causes differentiated delivery of the second protocol-based message based on a priority level associated with one of a mission-critical service, a multimedia priority service, or a higher-tier enterprise service. In some implementations, encoding the first protocol-based message into the second protocol-based message includes one or more of mapping the priority level to a level of the priority header field, or converting a range of priority levels to respective ranges in the priority header field.

As further shown in FIG. 4, process 400 may include causing the second protocol-based message to be provided to a second UE associated with an intercarrier network (block 430). For example, the network device may cause the second protocol-based message to be provided to a second UE associated with an intercarrier network, as described above. In some implementations, causing the second protocol-based message to be provided to the second UE includes one or more of selecting a transmission path with an expedited routing option for the second protocol-based message, or suppressing non-priority message transmission while the second protocol-based message is provided to the second UE.

In some implementations, causing the second protocol-based message to be provided to the second UE includes encrypting the second protocol-based message during provision of the second protocol-based message to the second UE. In some implementations, causing the second protocol-based message to be provided to the second UE includes applying an integrity check to confirm that the priority header field remains unaltered during provision of the second protocol-based message to the second UE.

In some implementations, process 400 includes receiving, from the second UE, another second protocol-based message that includes the priority header field, encoding the other second protocol-based message into another first protocol-based message that includes the priority header information generated based on the priority header field, and causing the other first protocol-based message to be provided to the first UE.

In some implementations, process 400 includes queuing the second protocol-based message over other queued message based on the priority header field. In some implementations, process 400 includes caching the second protocol-based message in a priority message queue that is separate from a standard message queue. In some implementations, process 400 includes receiving, from the second UE, a confirmation of receipt of the second protocol-based message, and notifying the first UE of successful delivery of the first protocol-based message based on the confirmation of receipt of the second protocol-based message. In some implementations, process 400 includes monitoring network congestion levels, and dynamically adapting a transmission priority of the second protocol-based message based on the network congestion levels and in accordance with the priority header field.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, a first protocol-based message that includes priority header information indicative of a priority level associated with a first user equipment (UE);
encoding, by the network device, the first protocol-based message into a second protocol-based message that includes a priority header field generated based on the priority header information; and
causing, by the network device, the second protocol-based message to be provided to a second UE associated with an intercarrier network.

2. The method of claim 1, further comprising:
queuing the second protocol-based message over other queued message based on the priority header field.

3. The method of claim 1, further comprising:
caching the second protocol-based message in a priority message queue that is separate from a standard message queue.

4. The method of claim 1, wherein the first protocol-based message is a Session Initiation Protocol (SIP)-based message, and the second protocol-based message is a Short Message Peer-to-Peer (SMPP) protocol-based message.

5. The method of claim 1, wherein the priority header field includes a plurality of priority levels for routing the second protocol-based message.

6. The method of claim 1, wherein the priority header field causes differentiated delivery of the second protocol-based message based on a priority level associated with one of a mission-critical service, a multimedia priority service, or a higher-tier enterprise service.

7. The method of claim 1, further comprising:
receiving, from the second UE, another second protocol-based message that includes the priority header field;
encoding the other second protocol-based message into another first protocol-based message that includes the priority header information generated based on the priority header field; and
causing the other first protocol-based message to be provided to the first UE.

8. A network device, comprising:
one or more processors configured to:
receive a first protocol-based message that includes priority header information indicative of a priority level associated with a first user equipment (UE);
encode the first protocol-based message into a second protocol-based message that includes a priority header field generated based on the priority header information;
queue the second protocol-based message over other queued message based on the priority header field; and
cause the second protocol-based message to be provided to a second UE associated with an intercarrier network.

9. The network device of claim 8, wherein the one or more processors, to cause the second protocol-based message to be provided to the second UE, are configured to one or more of:
select a transmission path with an expedited routing option for the second protocol-based message; or
suppress non-priority message transmission while the second protocol-based message is provided to the second UE.

10. The network device of claim 8, wherein the one or more processors, to encode the first protocol-based message into the second protocol-based message, are configured to one or more of:
map the priority level to a level of the priority header field; or
convert a range of priority levels to respective ranges in the priority header field.

11. The network device of claim 8, wherein the one or more processors are further configured to:
receive, from the second UE, a confirmation of receipt of the second protocol-based message; and
notify the first UE of successful delivery of the first protocol-based message based on the confirmation of receipt of the second protocol-based message.

12. The network device of claim 8, wherein the one or more processors, to cause the second protocol-based message to be provided to the second UE, are configured to:
encrypt the second protocol-based message during provision of the second protocol-based message to the second UE.

13. The network device of claim 8, wherein the one or more processors, to cause the second protocol-based message to be provided to the second UE, are configured to:
apply an integrity check to confirm that the priority header field remains unaltered during provision of the second protocol-based message to the second UE.

14. The network device of claim 8, wherein the one or more processors are further configured to:
monitor network congestion levels; and
dynamically adapt a transmission priority of the second protocol-based message based on the network congestion levels and in accordance with the priority header field.

15. A non-transitory computer-readable medium storing a set of instructions, the set of instructions comprising:
one or more instructions that, when executed by one or more processors of a network device, cause the network device to:
receive a first protocol-based message that includes priority header information indicative of a priority level associated with a first user equipment (UE);
encode the first protocol-based message into a second protocol-based message that includes a priority header field generated based on the priority header information, wherein the priority header field includes a plurality of priority levels for
routing the second protocol-based message; and
cause the second protocol-based message to be provided to a second UE associated with an intercarrier network.

16. The non-transitory computer-readable medium of claim 15, wherein the one or more instructions further cause the network device to:
receive, from the second UE, another second protocol-based message that includes the priority header field;
encode the other second protocol-based message into another first protocol-based message that includes the priority header information generated based on the priority header field; and
cause the other first protocol-based message to be provided to the first UE.

17. The non-transitory computer-readable medium of claim 15, wherein the one or more instructions further cause the network device to:
cache the second protocol-based message in a priority message queue that is separate from a standard message queue.

18. The non-transitory computer-readable medium of claim 15, wherein the one or more instructions, that cause the network device to cause the second protocol-based message to be provided to the second UE, cause the network device to one or more of:
select a transmission path with an expedited routing option for the second protocol-based message; or
suppress non-priority message transmission while the second protocol-based message is provided to the second UE.

19. The non-transitory computer-readable medium of claim 15, wherein the one or more instructions, that cause the network device to encode the first protocol-based message into the second protocol-based message, cause the network device to one or more of:
map the priority level to a level of the priority header field; or convert a range of priority levels to respective ranges in the priority header field.

20. The non-transitory computer-readable medium of claim 15, wherein the one or more instructions further cause the network device to:
receive, from the second UE, a confirmation of receipt of the second protocol-based message; and
notify the first UE of successful delivery of the first protocol-based message based on the confirmation of receipt of the second protocol-based message.
